(19) United States
(12) Patent Application Publication
(10) Pub. No.: US 2012/0128468 A1
(43) Pub. Date: May 24, 2012

(54) SENSOR ASSEMBLY FOR USE WITH A TURBOMACHINE AND METHODS OF ASSEMBLING SAME

(76) Inventors: Kurt Kramer Schleif, Greenville, SC (US); Kevin Leon Bruce, Greer, SC (US); Shawn Carrol Yates, Houston, TX (US); Leissner Ferdinand Poth, III, Simpsonvlle, SC (US); Derek Ray Wilson, Greenville, SC (US)

(21) Appl. No.: 12/951,156

(22) Filed: Nov. 22, 2010

(51) Int. Cl. F04D 29/00; G01K 11/22; B23P 11/00

(52) U.S. Cl. 415/118; 29/428; 374/117; 374/E11.009

(57) ABSTRACT

A method for assembling a sensor assembly for use with a turbomachine is provided. The method includes providing a cover that includes a first portion and a second portion that extends from the first portion. A cavity is defined within the first portion. Moreover, a sensing device that is configured to measure at least one variable of a component of the turbomachine is inserted into the cavity. The second portion is removably coupled to a surface of the turbomachine component such that the cover securely couples the sensing device to the turbomachine component.

### BACKGROUND OF THE INVENTION

The field of the invention relates generally to turbomachines and, more particularly, to a sensor assembly that can be used with a turbomachine.

At least some known turbomachines, such as turbine engines, operate with high-temperature fluids. For example, at least some known turbine engines include components, such as turbine blades that channel high-temperature fluids therethrough. Continued exposure to high temperatures may cause damage to some components, such as inducing corrosion on the surfaces of the components or causing heat-related cracking of other components. Continued operation with a worn or damaged component may cause additional damage to other components or may lead to a failure of other components of the system. As such, generally, the operating temperature of a turbine engine and its associated components is monitored to ensure safe operation of the turbine engine and to ensure desired life for the engine components.

Various known methods and sensor systems have been used to determine the temperature of a turbine engine and its associated components. For example, acquiring temperature data from components, such as rotating components, is often accomplished using several techniques and instrumentations, such as thermocouples and/or pyrometry. Crystal temperature sensors may also be used to determine the temperature of a rotating component. At least some known crystal temperature sensors provide a single data point that corresponds to an approximate value of the maximum temperature the crystal was exposed to. In implementing a crystal temperature sensor, typically a sensor is coupled to a turbine engine component. For example, crystal temperature sensors may be coupled to rotating components, such as rotor blades, wheels, or spacers. Crystal temperature sensors may also be coupled to stationary components, such as nozzles, stator blades, shrouds, combustion hardware, casings, etc. In fact, crystal temperature sensors may be used on all three “main” sections of the turbine, including the compressor, combustors, and/or turbine.

However, acquiring data from some turbine engine components, such as rotating components, may be costly, inefficient and/or labor intensive. For example, at least some known crystal temperature sensors are coupled to a turbine component, by altering the shape and/or composition of the turbine component. For example, to couple a crystal temperature sensor to a turbine blade, the turbine blade may require machining to create a recess within the turbine blade that is sized to receive the crystal therein. As such, to couple a crystal temperature sensor to a blade, prior to each test, the turbine blade must be removed from the engine to enable the sensor to be coupled within the blade. Moreover, after the test is completed, the blade must be removed from the turbine engine in order to have the sensor analyzed.

### BRIEF DESCRIPTION OF THE INVENTION

In one embodiment, a method for assembling a sensor assembly for use with a turbomachine is provided. The method includes providing a cover that includes a first portion and a second portion that extends from the first portion. A cavity is defined within the first portion. Moreover, a sensing device that is configured to measure at least one variable of a component of the turbomachine is inserted into the cavity. The second portion is removably coupled to a surface of the turbomachine component such that the cover securely couples the sensing device to the turbomachine component.

In another embodiment, a sensor assembly for use with a turbomachine is provided. The sensor assembly includes a sensing device that is configured to measure at least one variable of a component of the turbomachine. Moreover, the sensor assembly includes a cover that is configured to secure the sensing device to the turbomachine component. The cover includes a first portion that includes a cavity defined therein and the cavity is sized to receive the sensing device therein. Moreover, the cover includes a second portion that extends from the first portion. The second portion is configured to be removably coupled to a surface of the turbomachine component.

In another embodiment, a turbomachine is provided. The turbomachine includes at least one component that is stationary and/or rotatable Moreover, the turbomachine includes at least one sensor assembly that is coupled to the component. The sensor assembly includes a sensing device that is configured to measure at least one variable of the component. Moreover, the sensor assembly includes a cover that is configured to secure the sensing device to the component. The cover includes a first portion that includes a cavity defined therein and the cavity is sized to receive the sensing device therein. Moreover, the cover includes a second portion that extends from the first portion. The second portion is configured to be removably coupled to a surface of the component.

### BRIEF DESCRIPTION OF THE DRAWINGS

FIG. 1 is a cross-sectional schematic view of an exemplary turbine engine;

FIG. 2 is a cross-sectional schematic view of an exemplary rotor assembly that may be used with the turbine engine shown in FIG. 1 and taken along area 2;

FIG. 3 is an enlarged cross-sectional schematic view of a portion of an exemplary sensor assembly that may be used with the rotor assembly shown in FIG. 2 and taken along line 3-3;

FIG. 4 is an exploded view of the sensor assembly shown in FIG. 3; and

FIG. 5 is an exemplary method that may be used for assembling the sensor assembly shown in FIG. 3.

### DETAILED DESCRIPTION OF THE INVENTION

The exemplary methods, apparatus and systems described herein overcome at least some known disadvantages of at least some known sensor systems used to acquire data from components of turbomachines. The embodiments described herein include a sensor assembly that includes a sensing device and a cover that securely couples the sensing device to a surface of a turbomachine component. More specifically, a portion of the cover may be removably coupled to the surface of the turbomachine component such that the sensor assembly may be readily coupled to, and removed from, the component surface. Because the sensor assembly is removably coupled to the surface of the turbomachine component, the component does not require any machining and/or altering to enable the sensing device to be coupled to or removed from the component. As such, removal of the machine component from the system is not required to perform testing.

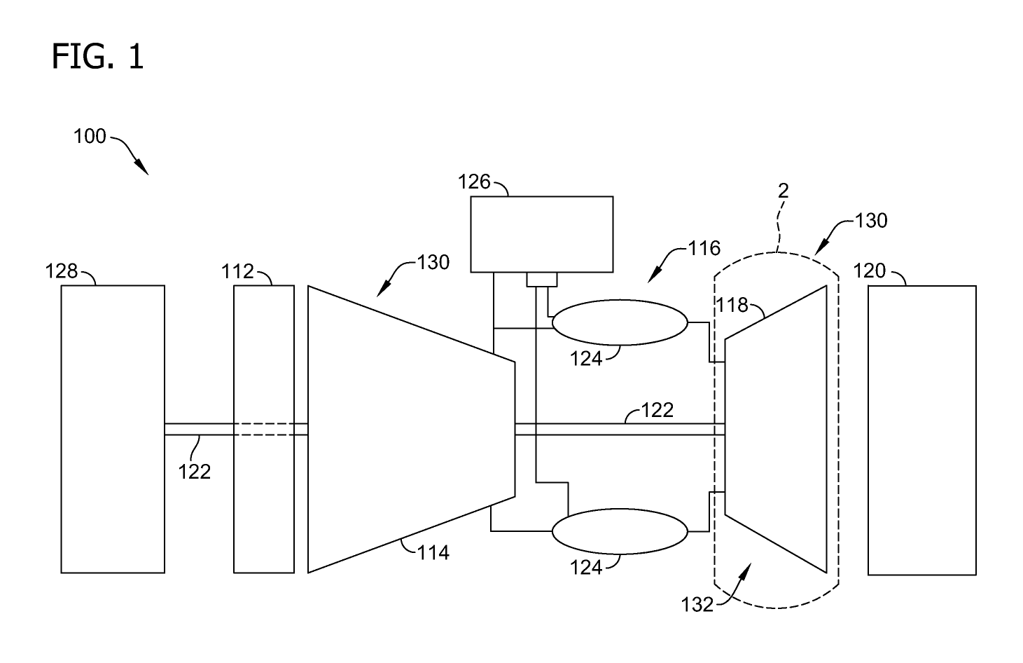

FIG. 1 is a schematic cross-sectional view of an exemplary turbine engine 100. More specifically, turbine engine 100 is a gas turbine engine. While the exemplary embodiment includes a gas turbine engine, the present invention is not limited to any one particular turbine engine or turbomachine, and one of ordinary skill in the art should appreciate that the current invention may be used in connection with other turbine engines or turbomachines that have stationary and/or rotating components. Moreover, one of ordinary skill in the art should appreciate that the current invention may also be used with other machines in various different technologies, such as in the automotive industry, and is not limited to turbine engines or turbomachines.

Moreover, in the exemplary embodiment, turbine engine 100 includes an intake section 112, a compressor section 114 coupled downstream from intake section 112, a combustor section 116 coupled downstream from compressor section 114, a turbine section 118 coupled downstream from combustor section 116, and an exhaust section 120. Turbine section 118 is coupled to compressor section 114 via a rotor shaft 122. In the exemplary embodiment, combustor section 116 includes a plurality of combustors 124. Combustor section 116 is coupled to compressor section 114 such that each combustor 124 is positioned in flow communication with the compressor section 114. A fuel nozzle assembly 126 is coupled to each combustor 124. Turbine section 118 is coupled to compressor section 114 and to a load 128 such as, but not limited to, an electrical generator and/or a mechanical drive application. In the exemplary embodiment, each compressor section 114 and turbine section 118 includes at least one rotor disk assembly 130 that is coupled to a rotor shaft 122 to form a rotor assembly 132.

During operation, intake section 112 channels air towards compressor section 114 wherein the air is compressed to a higher pressure and temperature prior to being discharged towards combustor section 116. The compressed air is mixed with fuel and ignited to generate combustion gases that are channeled towards turbine section 118. More specifically, in combustors 124, fuel, for example, natural gas and/or fuel oil, is injected into the air flow, and the fuel-air mixture is ignited to generate high temperature combustion gases that are channeled towards turbine section 118. Turbine section 118 converts the thermal energy from the gas stream to mechanical rotational energy, as the combustion gases impart rotational energy to turbine section 118 and to rotor assembly 132.

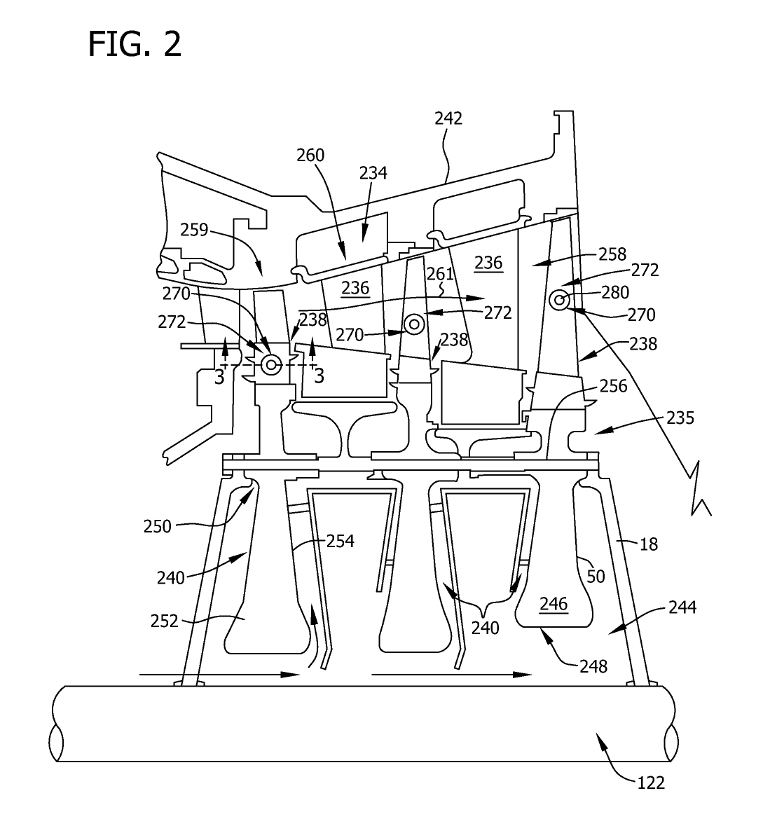

FIG. 2 is a cross-sectional schematic view of rotor assembly 132. In the exemplary embodiment, turbine section 118 includes a plurality of stages 234 that each includes a rotating rotor disk assembly 235 and a stationary row of stator vanes 236. In the exemplary embodiment, each rotor disk assembly 235 includes a plurality of turbine blades 238 coupled to a rotor disk 240. Each rotor disk 240 is coupled to rotor shaft 122. A turbine casing 242 extends circumferentially about turbine blades 238 and stator vanes 236, such that each stator vane 236 is supported by casing 242.

In the exemplary embodiment, each rotor disk 240 is annular and includes a central bore 244 defined therein that extends substantially axially therethrough. More specifically, each disk body 246 extends radially outwardly from central bore 244. Moreover, central bore 244 is sized to receive rotor shaft 122 therethrough. Disk body 246 extends radially between a radially inner edge 248 and a radially outer edge 250, and axially from an upstream surface 252 to an opposite downstream surface 254. Each upstream surface 252 and downstream surface 254 extends between inner edge 248 and outer edge 250. An axial support arm 256 is coupled between adjacent rotor disks 240 to form rotor assembly 132.

Moreover, in the exemplary embodiment, each turbine blade 238 is coupled to disk body 246 and extends radially outwardly therefrom. In the exemplary embodiment, turbine blades 238 are spaced circumferentially about rotor disk 240. Adjacent rotor disks 240 are spaced such that a gap 258 is defined between each row 259 of circumferentially-spaced turbine blades 238. Gap 258 is sized to receive a row 260 of circumferentially-spaced stator vanes 236 that each extend inwardly from turbine casing 242 towards rotor shaft 122. More specifically, in the exemplary embodiment, stator vanes 236 are spaced circumferentially about rotor shaft 122 and are oriented to channel combustion gases downstream towards turbine blades 238.

In the exemplary embodiment, a hot gas path 261 is defined between turbine casing 242 and each rotor disk 240. Each row 259 and 260 of turbine blades 238 and stator vanes 236 extends at least partially through a portion of hot gas path 261. Moreover, in the exemplary embodiment, at least one sensor assembly 270 that includes a sensing device (not shown in FIG. 2) is removably coupled to an exterior surface 272 of at least one turbine blade 238. Alternatively, sensor assembly 270 may be coupled to a surface of any component of turbine engine 100 that enables sensor assembly 270 to function as described herein. For example, sensor assembly may be coupled to a surface in compressor section 114 (shown in FIG. 1), combustor section 124 (shown in FIG. 1), exhaust 120 (shown in FIG. 1) and/or on rotor shaft 122.

Moreover, in the exemplary embodiment, sensor assembly 270 includes a cover 280 that secures the sensing device to each blade exterior surface 272. In the exemplary embodiment, cover 280 is substantially circular. Alternatively, cover 280 may have any shape or be any size that enables sensor assembly 270 to function as described herein. Moreover, in the exemplary embodiment, the sensing device measures the approximate maximum temperature of surface 272 of turbine blade 238. Alternatively, the sensing device may be configured to measure any variable, such as operating pressure within turbine blade 238.

During operation, compressor section 114 (shown in FIG. 1) compresses air and discharges compressed air through combustor section 116 (shown in FIG. 1) and towards turbine section 118. More specifically, the majority of air discharged from compressor section 114 is channeled towards combustor section 116, and a smaller portion of air discharged from compressor section 114 is channeled downstream towards turbine section 118 for use in cooling rotor assembly 132. More specifically, pressurized compressed air is channeled to combustors 124 (shown in FIG. 1) wherein the air is mixed with fuel and ignited to generate high temperature combustion gases. The combustion gases are then channeled towards hot gas path 261, wherein the gases impinge upon turbine blades 238 to facilitate imparting a rotational force on rotor assembly 132. As the combustion gases impinge upon turbine blades 238, heat transferred to turbine blades 238 causes an operating temperature of surface 272 to substantially increase. While turbine blades 238 are rotating, sensor assembly 270 secures the sensing device to surface 272 of turbine blade 238 to enable the sensing device to measure the approximate value for the maximum temperature of surface 272.

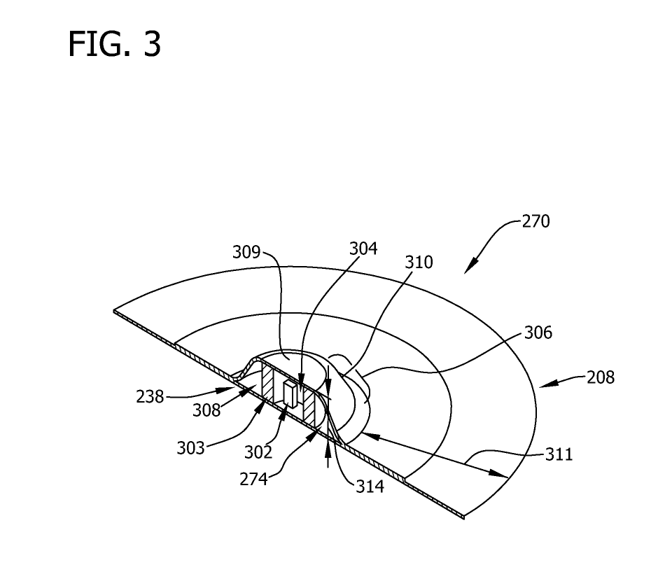

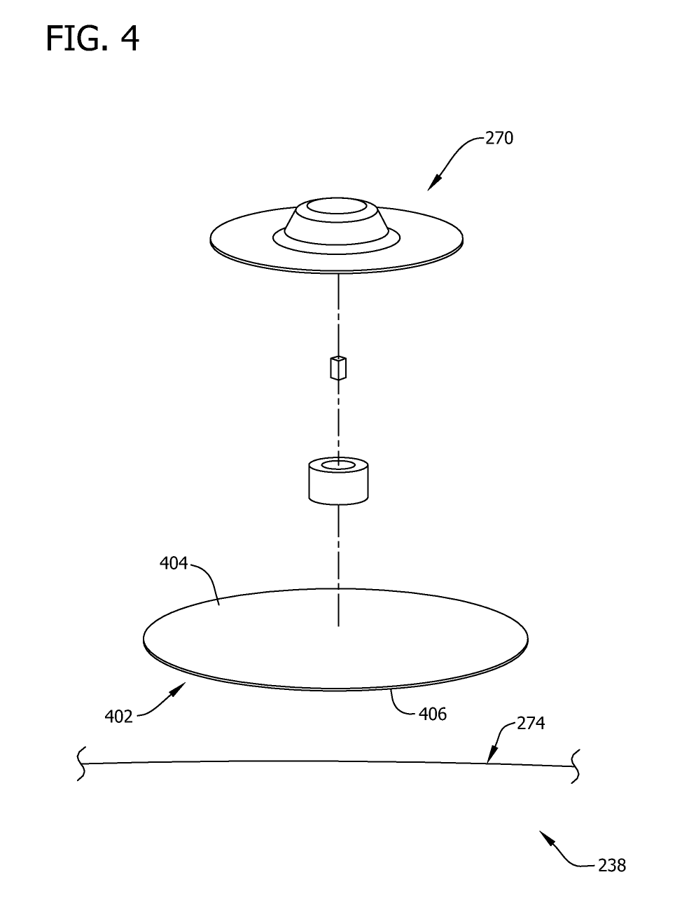

FIG. 3 is an enlarged cross-sectional view of sensor assembly 270. FIG. 4 is an exploded view of sensor assembly 270. Identical components shown in FIG. 3 are labeled with the same reference numbers used in FIG. 2. Sensor assembly 270 includes a sensing device 302. In the exemplary embodiment, sensing device 302 is a silicon carbide (SiC) crystal temperature sensor that is configured to measure the approximate value for the maximum temperature of surface 272 of turbine blade 238. Alternatively, sensing device 302 may be used to measure the approximate value for the maximum temperature of any component of turbine engine 100 (shown in FIG. 1)

Sensor assembly 270 also includes a tube 303 that substantially encloses sensing device 302. More specifically, in the exemplary embodiment, tube 303 includes a bore 304 that extends substantially axially through tube 303. In the exemplary embodiment, tube 303 is thin-walled tube fabricated from a rigid material such that tube 303 can be cut and the ends can be crimped by imparting a force on tube 303. Alternatively, tube 303 can be fabricated from any material that enables sensor assembly 270 to function as described herein.

In the exemplary embodiment, sensing device 302 is positioned within bore 304 such that tube 303 substantially encapsulates sensing device 302. More specifically, in the exemplary embodiment, bore 304 includes filler material (not shown) therein for use in containing sensing device 302 within bore 304. In the exemplary embodiment, sensing device 302 is immersed within the filler material while the filler material is in a liquid state. Moreover, in the exemplary embodiment, after the filler material has dried, the ends (not shown) of tube 303 are left open and are not crimped together. Alternatively, the ends of tube 303 may be crimped together. In the exemplary embodiment, the filler material is a high-temperature potting material. Alternatively, filler material may be any material that enables sensor assembly 270 to function as described herein.

Moreover, in the exemplary embodiment, sensor assembly cover 280 secures sensing device 302 to turbine blade 238. In the exemplary embodiment, cover 280 is formed from nichrome foil material. Alternatively, cover 280 may be formed from any metal alloy material and/or a metallic material. Alternatively, cover 280 may be formed from any other material that enables sensor assembly 270 to function as described herein.

In the exemplary embodiment, cover 280 includes a first portion 306 that includes a cavity 308 defined therein. Cavity 308 is sized and oriented to receive sensing device 302. More specifically, in the exemplary embodiment, tube 303, along with sensing device 302 positioned therein, is positioned within cavity 308. Alternatively, sensing device 302 may be positioned in cavity 308 without tube 303. For example, sensing device 302 may be immersed within the filler material in cavity 308 while the filler material is in a liquid state. Once the filler material is dry, sensing device 302 is substantially encapsulated in cavity 308 such that cover 280 and sensing device 302 may be removably coupled to turbine blade 238.

Moreover, in the exemplary embodiment, first portion 306 includes a substantially circular top 309 and a sidewall 310 that extends outwardly from top 309 such that cavity 308 is defined therein. Alternatively, top 309 and sidewall 310 may be any shape that enables sensor assembly 270 to function as described herein.

Further, in the exemplary embodiment, top 309 is removably coupled to sidewall 310 such that top 309 may be selectively removed to position sensing device 302 within cavity 308. Alternatively, top 309 and sidewall 310 may be formed integrally together such that cover 280 may be inverted to position sensing device 302 within cavity 308.

In the exemplary embodiment, cover 280 also includes a second portion 311 that extends laterally from first portion 306. More specifically, second portion 311 extends from sidewall 310. In the exemplary embodiment, second portion 311 is integrally formed with first portion 306. More specifically, second portion 311 is integrally formed with sidewall 310. Alternatively, second portion 311 may be removably coupled to first portion 306.

Moreover, in the exemplary embodiment, top 309 is spaced a distance 314 from second portion 311. In the exemplary embodiment, distance 314 is at least 0.024 millimeters from second portion 311 to ensure sensing device 302 and/or tube 303 are enclosed. Alternatively, distance 314 may be any length that enables sensing device 302 and/or tube 303 to be enclosed and that enables sensor assembly 270 to function as described herein.

Cover second portion is removably coupled to surface 272 of turbine blade 238 (shown in FIG. 2) such that cover 280 substantially secures sensing device 302 to surface 272. More specifically, second portion 311 is coupled to surface 272 via a tack welding process. Alternatively, second portion 311 may be coupled to surface 272 using any other fastening means that enables cover 280 to be removably coupled to turbine blade 238 and that enables sensor assembly 270 to function as described herein. Moreover, in the exemplary embodiment, second portion 311 is removed via a tool (not shown), such as a blade, facilitates removing sensor assembly 270 from turbine blade 238.

In the exemplary embodiment, sensor assembly 270 includes a base 402 having a first surface 404 and a second surface 406. In the exemplary embodiment, base 402 is formed from nichrome foil material. Alternatively, base 402 may be formed from any metal alloy material and/or a metallic material. Alternatively, base 402 may be fabricated from any material that enables sensor assembly 270 to function as described herein. Moreover, in the exemplary embodiment base 402 is substantially circular. Alternatively, base 402 may be any shape that enables sensor assembly 270 to function as described herein.

Moreover, in the exemplary embodiment, base 402 is coupled to cover 280. More specifically, after sensing device 302 is enclosed by tube 303 such that both tube 303 and sensing device 302 are positioned within cavity 308 (shown in FIG. 3), cover 280 is then coupled to base 402. In the exemplary embodiment, cover 280 is coupled to base 402 such that cover 280 and base 402 at least partially enclose sensing device 302 and tube 303. Moreover, in the exemplary embodiment, second portion 311 is coupled to first surface 404 of base 402 via a tack welding process. Alternatively, second portion 311 may be coupled to first surface 404 of base 402 using any other fastening means that enables cover 280 to be removably coupled to base 402.

Base 402 is removably coupled to turbine blade 238. More specifically, in the exemplary embodiment, second surface 406 of base 402 is coupled to surface 272 of turbine blade 238 via a tack welding process. Alternatively, base 402 may be coupled to surface 272 using any other fastening means that enables sensor assembly 270 to be removably coupled to turbine blade 238 and that enables sensor assembly 270 to function as described herein. Moreover, in the exemplary embodiment, once a test has been completed, base 402 is removed via a tool (not shown), such as a blade, that can remove sensor assembly 270 from turbine blade 238. Further, sensing device 302 is extracted from the filler by mechanically removing the filler. Alternatively, sensing device 302 may be extracted from the filler using any method known in the art that enables sensor assembly 270 to function as described herein.

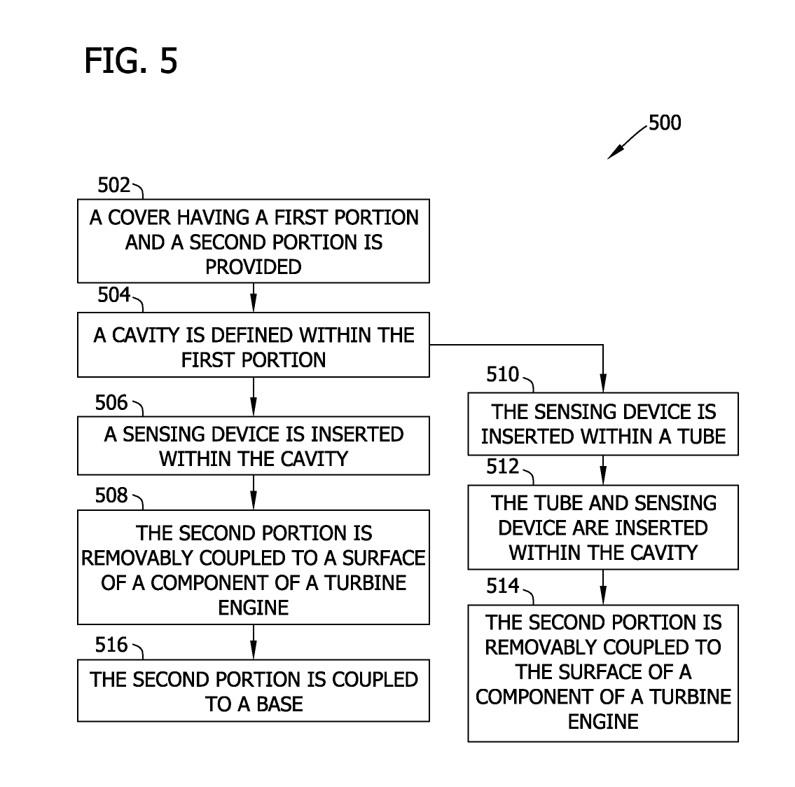

FIG. 5 illustrates an exemplary method 500 that may be used to assemble a sensor assembly, such as sensor assembly 270 (shown in FIGS. 2, 3 and 4) for use with turbine engine 100 (shown in FIG. 1). In the exemplary embodiment, a cover 280 (shown in FIGS. 2, 3 and 4) having a first portion 306 (shown in FIGS. 3 and 4) and a second portion 311 (shown in FIGS. 3 and 4) that extends laterally from first portion 306 is provided 502. A cavity 308 (shown in FIG. 3) is defined 504 within first portion 306. A sensing device 302 (shown in FIGS. 3 and 4) that is configured to measure at least one variable of a component of turbine engine 100 is then inserted 506 within cavity 308. Second portion 311 is then removably coupled 508 to a surface 272 (shown in FIGS. 2, 3 and 4) of turbine blade 238 such that cover 280 substantially secures sensing device 302 to turbine blade 238.

Prior to being inserted 506 within cavity, sensing device 302 is inserted 510 within a bore 304 (shown in FIGS. 3 and 4) extending substantially axially through a tube 303 (shown in FIGS. 3 and 4). Then tube 303, along with sensing device 302, is inserted 512 within cavity 308. Second portion 311 is then removably coupled 514 to blade surface 272 such that cover 280 substantially secures tube 303, with sensing device 302 positioned therein, to turbine blade 238.

When second portion 311 is removably coupled 508 to surface 272, second portion 311 is coupled 516 to a base 402 (shown in FIG. 4), wherein base 402 is removably coupled to surface 272 of turbine blade 238 such that base 402 and cover 280 at least partially enclose sensing device 302.

The above-described sensor assembly provides a cost effective and an efficient way to monitor and test components of a turbomachine. More specifically, the embodiments described herein provide a sensor assembly that includes a sensing device and a cover that secures the sensing device to an outer surface of a turbomachine component. More specifically, the cover includes a first portion that defines a cavity therein. The cavity is sized and shaped to receive the sensing device and the cover includes a second portion that extends laterally from the first portion. The second portion is configured to be removably coupled to another surface of the turbomachine component such that the sensor assembly may be readily coupled to and removed from the surface. Because the sensor assembly is removably coupled to the surface of the turbomachine component, the component is not required to undergo any machining and/or altering in order for the sensing device to be coupled to or removed from the component. As such, removal of the entire machine component is not required prior to and/or after conducting a test.

Exemplary embodiments of a sensor assembly and methods of assembling same are described above in detail. The sensor assembly and methods of assembling same are not limited to the specific embodiments described herein, but rather, components of the sensor assembly and/or steps of the sensor assembly may be utilized independently and separately from other components and/or steps described herein. For example, the sensor assembly may also be used in combination with other machines and methods, and is not limited to practice with only the turbine engine as described herein. Rather, the exemplary embodiment can be implemented and utilized in connection with many other systems.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for assembling a sensor assembly for use with a turbomachine, said method comprising:
providing a cover including a first portion and a second portion that extends laterally from the first portion;
defining a cavity within the first portion;
inserting a sensing device configured to measure at least one variable of a component of the turbomachine within the cavity; and
coupling removably the second portion to a surface of the turbomachine component such that the cover securely couples the sensing device to the turbomachine component.

2. A method in accordance with claim 1 further comprising positioning the sensing device within a bore extending substantially axially through a tube.

3. A method in accordance with claim 2 further comprising inserting the tube including the sensing device positioned therein within the cavity.

4. A method in accordance with claim 1, wherein said coupling the second portion further comprises removably coupling the second portion to a base such that the base and the cover at least partially enclose the sensing device.

5. A method in accordance with claim 1, wherein said providing a cover further comprises providing a cover that includes a first portion that includes a top and a sidewall coupled to the top.

6. A method in accordance with claim 5, wherein the second portion is coupled to the sidewall.

7. A method in accordance with claim 1, wherein said inserting a sensing device further comprises inserting a crystal temperature sensor within the cavity.

8. A sensor assembly for use with a turbomachine, said sensor assembly comprising:
a sensing device configured to measure at least one variable of a component of the turbomachine; and
a cover configured to secure said sensing device to the turbomachine component, said cover comprising:
a first portion including a cavity defined therein, said cavity sized to receive said sensing device therein; and
a second portion extending from said first portion, said second portion is configured to be removably coupled to a surface of the turbomachine component.

9. A sensor assembly in accordance with claim 8 further comprising a tube comprising a bore extending substantially axially therethrough, said cover is configured to securely couple said tube to the turbomachine component.

10. A sensor assembly in accordance with claim 8 further comprising a base coupled to said second portion, said base is configured to be removably coupled to the turbomachine component.

11. A sensor assembly in accordance with claim 8, wherein said first portion comprises a top and a sidewall extending from said top, said second portion is coupled to said sidewall.

12. A sensor assembly in accordance with claim 8, wherein said first portion is formed integrally with said second portion.

13. A sensor assembly in accordance with claim 8, wherein said sensing device is a crystal temperature sensor.

14. A sensor assembly in accordance with claim 8, wherein said cover is formed from at least one of a metal alloy material and a metallic material.

15. A sensor assembly in accordance with claim 8, wherein said cover is formed from a nichrome foil material.

16. A turbomachine comprising:
at least one component that is at least one of stationary and rotatable;
at least one sensor assembly coupled to said at least one component, said at least one sensor assembly comprising:
a sensing device configured to measure at least one variable of said at least one component; and
a cover configured to secure said sensing device to said at least one component, said cover comprises a first portion including a cavity defined therein, said cavity sized to receive said sensing device therein, said cover further comprises a second portion extending from said first portion, said second portion is configured to be removably coupled to a surface of said at least one component.

17. A turbomachine in accordance with claim 16, wherein said at least one sensor assembly further comprises a tube comprising a bore extending substantially axially therethrough, said cover is configured to securely couple said tube to said at least one component.

18. A turbomachine in accordance with claim 16, wherein said at least one sensor assembly further comprises a base coupled to said second portion, said base is configured to be removably coupled to said at least one component.

19. A turbomachine in accordance with claim 16, wherein said sensing device is a crystal temperature sensor.

20. A turbomachine in accordance with claim 16, wherein said cover is formed from a nichrome foil material.
